(19) United States
(12) Patent Application Publication
(10) Pub. No.: US 2026/0097815 A1
(43) Pub. Date: Apr. 9, 2026

(54) VEHICLE FRAME STRUCTURE

(71) Applicant: TOYOTA JIDOSHA KABUSHIKI KAISHA, Toyota-shi (JP)

(72) Inventor: Katsunori HIGASHIHARA, Toyota-shi (JP)

(21) Appl. No.: 19/322,709

(22) Filed: Sep. 9, 2025

(30) Foreign Application Priority Data
Oct. 3, 2024 (JP) 2024-174499

(51) Int. Cl. B62D 27/02; B62D 21/03; B62D 25/02

(52) U.S. Cl. CPC B62D 27/02; B62D 21/03; B62D 25/025

(57) ABSTRACT

A vehicle frame structure includes: a pair of rockers that are provided at both vehicle width direction sides, and that extend in a vehicle front-rear direction; a cross member that is provided between the pair of rockers apart from the rockers, that extends in a vehicle width direction, and that includes inclined portions that are inclined downward on progression from a vehicle width direction inner side toward a vehicle width direction outer side at both vehicle width direction sides; and a spacer member configured to include an outer side vertical wall portion that is in surface contact with a surface at a vehicle width direction inner side of a rocker, and an inner side inclined wall portion that is in contact with an inclined portion of the cross member.

### CROSS-REFERENCE TO RELATED APPLICATION

This application is based on and claims priority under 35 USC 119 from Japanese Patent Application No. 2024-174499, filed on October 3, 2024, the disclosure of which is incorporated by reference herein.

### BACKGROUND

### Technical Field

The present disclosure relates to a vehicle frame structure.

### Related Art

Chinese Patent Application Publication No. 114937842 discloses a structure in which a floor panel of a vehicle is configured by a cover plate of a battery in a vehicle in which the battery is installed at a lower portion of the vehicle.

In the structure disclosed in Chinese Patent Application Publication No. 114937842, there is no need to separately provide a floor panel of the vehicle. In such a structure, a configuration in which a cross member (floor cross member) is provided at a battery case side has been studied in consideration of assemblability of the vehicle. However, in a case in which the cross member is fixed to the battery case, a gap is generated between a rocker and the cross member, and since the rocker will move freely until it contacts the cross member during a side collision, there is room for improvement from the perspective of improving collision safety performance during a side collision.

### SUMMARY

An object of the present disclosure is to obtain a vehicle frame structure that can improve collision safety performance during a side collision, even in a case in which a cross member and a rocker are arranged apart from each other.

A vehicle frame structure according to a first aspect includes: a pair of rockers that are provided at both vehicle width direction sides, and that extend in a vehicle front-rear direction; a cross member that is provided between the pair of rockers apart from the rockers, that extends in a vehicle width direction, and that includes inclined portions that are inclined downward on progression from a vehicle width direction inner side toward a vehicle width direction outer side at both vehicle width direction sides; and a spacer member configured to include an outer side vertical wall portion that is in surface contact with a surface at a vehicle width direction inner side of a rocker, and an inner side inclined wall portion that is in contact with an inclined portion of the cross member.

In the vehicle frame structure according to the first aspect, the rockers are provided at both vehicle width direction sides, and the pair of rockers each extend in the vehicle front-rear direction. Further, the cross member extending in the vehicle width direction is provided between the pair of rockers, and the cross member is apart from the rockers. Thus, due to the cross member being provided apart from the rockers, the cross member can be fixed to a battery case or the like.

In this regard, the cross member includes the inclined portions that are inclined downward on progression from the vehicle width direction inner side toward the vehicle width direction outer side at both vehicle width direction sides. Further, the spacer member is interposed between the rocker and the cross member, and the outer side vertical wall portion of the spacer member is in surface contact with the surface at the vehicle width direction inner side of the rocker. Furthermore, the inner side inclined wall portion of the spacer member is in contact with the inclined portion of the cross member. Consequently, a collision load can be transmitted from the rocker to the cross member via the spacer member during a side collision of the vehicle (hereinafter, sometimes referred to as a time of a side collision), and free movement of the rocker can be suppressed.

A vehicle frame structure according to a second aspect is the vehicle frame structure according to the first aspect, which further includes a bracket that is provided above the spacer member and that is fastened to the rocker and the cross member.

In the vehicle frame structure according to the second aspect, since the rocker and the cross member are connected to each other by the bracket, movement of the cross member away from the rocker can be suppressed.

A vehicle frame structure according to a third aspect is the vehicle frame structure according to the first aspect, wherein the spacer member includes a front wall portion that is fastened to the cross member in a state of being overlapped with a surface at a vehicle front side of the cross member, and a rear wall portion that is fastened to the cross member in a state of being overlapped with a surface at a vehicle rear side of the cross member.

In the vehicle frame structure according to the third aspect, the spacer member includes the front wall portion and the rear wall portion, and the front wall portion is fastened in a state of being overlapped with the surface at the vehicle front side of the cross member. Further, the rear wall portion is fastened in a state of being overlapped with the surface at the vehicle rear side of the cross member. Consequently, the spacer member can be fixed at the front and the rear of the cross member.

A vehicle frame structure according to a fourth aspect is the vehicle frame structure according to the first aspect, wherein the inclined portions are formed further upward than a lower end portion of the cross member.

In the vehicle frame structure according to the fourth aspect, a height of the spacer member in the up-down direction can be designed to be smaller than in a structure in which the inclined portions are formed extending to the lower end portion of the cross member.

A vehicle frame structure according to a fifth aspect is the vehicle frame structure according to the first aspect, wherein the spacer member includes a flange portion that extends in the vehicle front-rear direction along the rocker from the outer side vertical wall portion, and the flange portion and the rocker are fastened to each other.

In the vehicle frame structure according to the fifth aspect, due to the flange portion of the spacer member being fastened to the rocker, the rocker and the spacer member can be modularized in advance.

As explained above, the vehicle frame structure according to the present disclosure can improve collision safety performance during a side collision, even in a case in which a cross member and a rocker are arranged apart from each other.

### BRIEF DESCRIPTION OF THE DRAWINGS

Exemplary embodiments of the present disclosure will be described in detail based on the following figures, wherein:

FIG. 1 is a perspective view illustrating relevant portions of a vehicle including a vehicle frame structure according to a first exemplary embodiment;

FIG. 2 is an enlarged cross-sectional view taken along line 2-2 in FIG. 1, which is illustrated an enlarged manner;

FIG. 3 is a perspective view illustrating a spacer member in the first exemplary embodiment;

FIG. 4 is a perspective view illustrating relevant portions of a vehicle including a vehicle frame structure according to a second exemplary embodiment; and

FIG. 5 is an enlarged cross-sectional view illustrating a vehicle frame structure according to a third exemplary embodiment in an enlarged manner.

### DETAILED DESCRIPTION

### First Exemplary Embodiment

A vehicle frame structure according to a first exemplary embodiment will be explained with reference to the drawings.

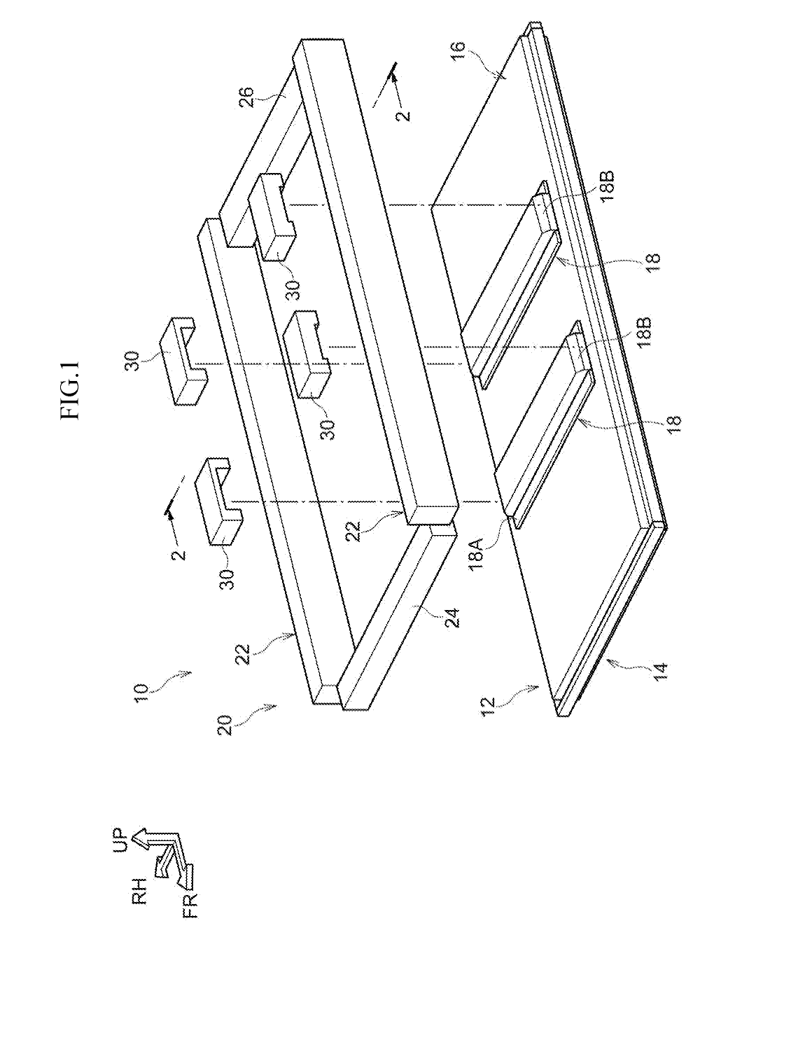

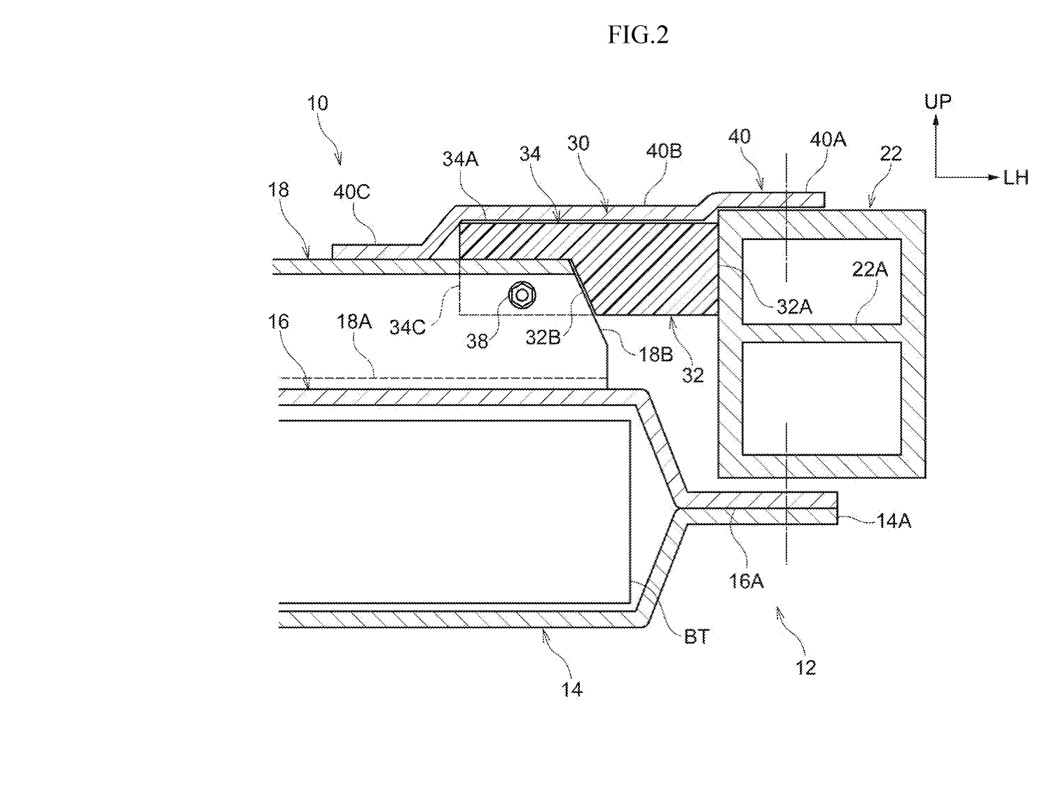

FIG. 1 is an exploded perspective view illustrating relevant portions of a vehicle 10 to which the vehicle frame structure according to the first exemplary embodiment has been applied. Further, FIG. 2 is an enlarged cross-sectional view taken along line 2-2 in FIG. 1, which is illustrated in an enlarged manner. It should be noted that arrow FR, arrow UP, arrow RH, and arrow LH in the drawings respectively indicate a vehicle frontward direction, a vehicle upward direction, a vehicle rightward direction, and a vehicle leftward direction of the vehicle 10. Unless specifically stated otherwise, in cases in which front and rear, up and down, and left and right directions are referred to in the following explanation, these respectively indicate front and rear in a vehicle front-rear direction, up and down in a vehicle up-down direction, and left and right in a vehicle left-right direction (width direction).

As illustrated in FIG. 1 and FIG. 2, the vehicle 10 of the present exemplary embodiment includes a battery case 12 at a vehicle lower portion. The battery case 12 is formed in a substantially rectangular box shape, and a battery BT is accommodated at an interior of the battery case 12.

The battery BT is, for example, a battery module in which plural battery cells are accommodated, and is accommodated at the interior of the battery case 12 in a state in which plural batteries BT are arrayed. Further, the battery BT is electrically connected to a drive motor, which is not illustrated in the drawings, and is used as a secondary battery that is capable of storing electric power to be supplied to the drive motor.

The vehicle 10 can be widely applied to vehicles that utilize electric power as at least a portion of a drive source, such as hybrid electric vehicles (HEV), plug-in hybrid electric vehicles (PHEV) and the like, in addition to battery electric vehicles (BEV) that use only a drive motor as a drive source.

The battery case 12 of the present exemplary embodiment is configured to include, as an example, a share panel 14 configuring a lower portion of the battery case 12, and a case cover 16 configuring an upper portion of the battery case 12.

The share panel 14 is formed in a substantially rectangular flat plate shape from sheet metal or the like, and an outer peripheral end portion of the share panel 14 is bent upward. Further, a lower side flange portion 14A extends out toward an outer peripheral side from the outer peripheral end portion of the share panel 14. The battery BT is supported from below in a region of the share panel 14 excluding the lower side flange portion 14A.

The case cover 16 is formed in a substantially rectangular flat plate shape from sheet metal or the like so as to cover the battery BT from above, and is bent downward at an outer peripheral end portion of the case cover 16. Further, an upper side flange portion 16A extends out toward an outer peripheral side from the outer peripheral end portion of the case cover 16, and the upper side flange portion 16A is joined to the lower side flange portion 14A of the share panel 14 by welding or the like in a state in which the upper side flange portion 16A is overlapped with the lower side flange portion 14A of the share panel 14. Furthermore, the upper side flange portion 16A and the lower side flange portion 14A are fastened to a rocker 22, which will be described later, by bolts and nuts, or the like, which are not illustrated in the drawings.

A cross member 18 is fixed to an upper surface of the case cover 16 of the battery case 12. In the present exemplary embodiment, as an example, two cross members 18 are fixed to the case cover 16 at an interval in the vehicle front-rear direction, but the number of the cross members 18 is not limited. Details of the cross members 18 will be described later.

As illustrated in FIG. 1, a battery frame 20 is provided above the battery case 12. The battery frame 20 is configured to include a left and right pair of rockers 22, a front cross member 24, and a rear cross member 26.

The rockers 22 are provided at both vehicle width direction end portions, and each extend in the vehicle front-rear direction. As illustrated in FIG. 2, each rocker 22 of the present exemplary embodiment is formed in a closed cross-sectional shape, and has a structure in which an internal space is partitioned in an up-down direction by a partition wall 22A; however, there is no limitation thereto, and other structures may be employed.

As illustrated in FIG. 1, the front cross member 24 is provided at a vehicle front portion, extends along the vehicle width direction, and connects front end portions of the left and right rockers 22 to each other in the vehicle width direction. Specifically, the front cross member 24 is formed as a closed cross-sectional structure with a substantially rectangular cross-section, from a steel plate or the like, and a right side end portion of the front cross member 24 is joined to the rocker 22 that is arranged at the right side. Further, a left side end portion of the front cross member 24 is joined to the rocker 22 that is arranged at the left side.

It should be noted that there is no particular limitation with regard to a method of joining the front cross member 24 and the rockers 22. For example, both end portions of the front cross member 24 may be joined to the rockers 22 by welding such as spot welding or the like. Further, both end portions of the front cross member 24 may be joined to the rockers 22 using fasteners such as bolts, nuts, rivets or the like.

Furthermore, the front cross member 24 may be integrally formed by metal extrusion, casting, or the like, in addition to a steel plate. The same also applies to the rear cross member 26, which will be described below.

The rear cross member 26 is provided at a vehicle rear portion, extends along the vehicle width direction, and connects rear end portions of the left and right rockers 22 to each other in the vehicle width direction. Specifically, the rear cross member 26 is formed as a closed cross-sectional structure with a substantially rectangular cross-section, from a steel plate or the like, and a right side end portion of the rear cross member 26 is joined to the rocker 22 that is arranged at the right side. Further, a left side end portion of the rear cross member 26 is joined to the rocker 22 that is arranged at the left side.

As described above, the battery frame 20 is configured in a substantially rectangular frame shape by the left and right pair of rockers 22, the front cross member 24, and the rear cross member 26, and is configured such that the battery case 12 is attached from below the battery frame 20. Specifically, the battery case 12 is fixed to the battery frame 20 by overlapping the battery case 12 from below the battery frame 20 and fastening the upper side flange portion 16A and the lower side flange portion 14A of the battery case 12 to the rockers 22, the front cross member 24, and the rear cross member 26.

The cross members 18 are positioned between the left and right rockers 22 and extend in the vehicle width direction, in a state in which the battery case 12 is fixed to the battery frame 20. Further, each cross member 18 is formed with a substantially hat-shaped cross-section, by press working a steel plate or the like, and a flange 18A is formed at a lower end portion of each cross member 18 (refer to FIG. 2). The flange 18A of each cross member 18 is joined to an upper surface of the case cover 16 by welding or the like in a state in which the flange 18A is overlapped with the upper surface of the case cover 16. It should be noted that the cross members 18 and the case cover 16 may also be fastened together by fasteners such as bolts and nuts or the like.

Inclined portions 18B are formed at both vehicle width direction end portions of the cross member 18. As illustrated in FIG. 2, each inclined portion 18B is inclined downward on progression from a vehicle width direction inner side toward a vehicle width direction outer side, and faces the rocker 22 in the vehicle width direction. Further, a gap is provided between the cross member 18 and the rocker 22. It should be noted that the inclined portions 18B of the present exemplary embodiment do not extend to a lower end portion of the cross member 18. In other words, the inclined portions 18B are formed further upward than the lower end portion of the cross member 18.

A spacer member 30 is arranged in the gap between the rocker 22 and the cross member 18. Although the spacer member 30 of the present exemplary embodiment is formed of a resin having a block shape, as one example, there is no limitation thereto, and the spacer member 30 may be formed of metal.

The spacer member 30 of the present exemplary embodiment is configured to include a base portion 32 and a fixing portion 34. The base portion 32 is a portion that is positioned between the rocker 22 and the cross member 18, and a surface at a vehicle width direction outer side of the base portion 32 is an outer side vertical wall portion 32A that is in surface contact with a surface at a vehicle width direction inner side of the rocker 22. It should be noted that the "surface contact" referred to herein is not limited to a configuration in which an entire area of the outer side vertical wall portion 32A is in surface contact with the rocker 22, but rather is a concept that broadly includes a configuration in which a portion of the outer side vertical wall portion 32A is in surface contact with the rocker 22.

A surface at a vehicle width direction inner side of the base portion 32 is an inner side inclined wall portion 32B that contacts the inclined portion 18B of the cross member 18. Specifically, the inner side inclined wall portion 32B is inclined toward the vehicle width direction outer side on progression from the vehicle upper side toward the vehicle lower side, and is formed at an inclination angle that corresponds to that of the inclined portion 18B of the cross member 18. Furthermore, the inner side inclined wall portion 32B is in surface contact with an end face of an upper portion of the inclined portion 18B of the cross member 18.

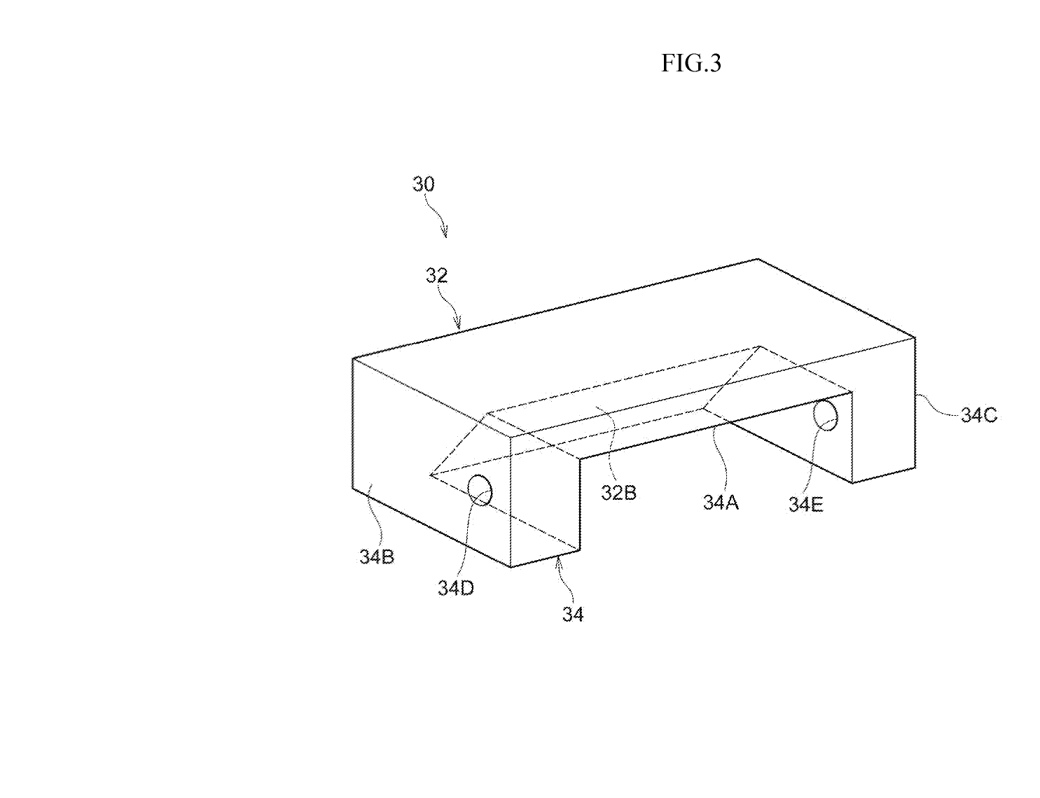

FIG. 3 is a perspective view illustrating the spacer member 30 of the first exemplary embodiment. As illustrated in FIG. 3, the fixing portion 34 of the spacer member 30 is formed substantially in a U-shape with a cross-section viewed along the vehicle width direction being open toward the vehicle lower side.

Specifically, the fixing portion 34 is configured to include an upper wall portion 34A that is positioned above, a front wall portion 34B that extends downward from a front end portion of the upper wall portion 34A, and a rear wall portion 34C that extends downward from a rear end portion of the upper wall portion 34A. The upper wall portion 34A extends in the vehicle width direction and the vehicle front-rear direction, and is overlapped with an upper surface of an end portion of the cross member 18 (refer to FIG. 2).

The front wall portion 34B extends in the vehicle width direction and the vehicle up-down direction, and is fastened to the cross member 18 in a state of being overlapped with a surface at a vehicle front side of the cross member 18. A through hole 34D is formed at the front wall portion 34B.

As illustrated in FIG. 2, the rear wall portion 34C has a shape to be fastened to the cross member 18 in a state of being overlapped with a surface at a vehicle rear side of an end portion of the cross member 18, and a through hole 34E is formed at the rear wall portion 34C.

Communication holes (which are not illustrated in the drawings) are respectively formed at positions corresponding to the through hole 34D and the through hole 34E of the spacer member 30, at the front surface and the rear surface of the cross member 18. Furthermore, weld nuts 38 are fixed at circumferences of the communication holes, and a configuration is provided such that the spacer member 30 is fixed to the cross member 18 by inserting and screwing bolts into the weld nuts 38 in a state in which positions of the through hole 34D and the through hole 34E of the spacer member 30 and the communication holes of the cross member 18 are aligned.

A bracket 40 is provided above the spacer member 30. The bracket 40 is a substantially rectangular plate-shaped metal member that extends in the vehicle width direction and the vehicle front-rear direction, and is arranged so as to straddle from the rocker 22 to the cross member 18. Furthermore, an entire area of the spacer member 30 is covered by the bracket 40 from the vehicle upper side.

The bracket 40 is configured to include an outer side fixing portion 40A, a center portion 40B, and an inner side fixing portion 40C. The outer side fixing portion 40A is fixed to the rocker 22 by a fastener, which is not illustrated in the drawings, in a state of being overlapped with an upper surface of the rocker 22.

The inner side fixing portion 40C is fixed to the cross member 18 by a fastener, which is not illustrated in the drawings, in a state of being overlapped with an upper surface of the cross member 18. The center portion 40B is positioned between the outer side fixing portion 40A and the inner side fixing portion 40C, and covers the spacer member 30 from above. Thus, the spacer member 30 is covered from above by the bracket 40, thereby suppressing falling-out of the spacer member 30 from between the rocker 22 and the cross member 18.

### Operation

Next, operation of the vehicle frame structure according to the present exemplary embodiment will be explained.

As illustrated in FIG. 1, in the vehicle 10 to which a vehicle frame structure according to the present exemplary embodiment is applied, the rockers 22 are provided at both vehicle width direction sides, and the pair of rockers 22 each extend in the vehicle front-rear direction. Further, the cross members 18 that extend in the vehicle width direction are provided between the pair of rockers 22, and the cross members 18 are apart from the rockers 22. By providing the cross members 18 so as to be apart from the rockers 22 in this manner, the cross members 18 can be fixed to the battery case 12 or the like.

Especially in structures in which the case cover 16 of the battery case 12 is used as a floor panel as in the vehicle 10 of the present exemplary embodiment, by fixing the cross members 18 to the case cover 16 in advance, assembly work efficiency of the vehicle 10 can be greatly improved.

Further, as illustrated in FIG. 2, in the vehicle frame structure of the present exemplary embodiment, the cross members 18 include the inclined portions 18B that are inclined downward on progression from the vehicle width direction inner side toward the vehicle width direction outer side at both vehicle width direction sides. Furthermore, the spacer member 30 is interposed between the rocker 22 and the cross member 18, and the outer side vertical wall portion 32A of the spacer member 30 is in surface contact with the surface at the vehicle width direction inner side of the rocker 22. Moreover, the inner side inclined wall portion 32B of the spacer member 30 is in contact with the inclined portion 18B of the cross member 18. Consequently, a collision load can be transmitted from the rocker 22 to the cross member 18 via the spacer member 30 at a time of a side collision of the vehicle 10, and free movement of the rocker 22 can be suppressed. Thus, in the vehicle frame structure of the present exemplary embodiment, collision safety performance during a side collision can be improved, even in a case in which the cross members 18 and the rockers 22 are arranged so as to be apart from each other.

Further, in the present exemplary embodiment, since the rocker 22 and the cross member 18 are connected to each other by the bracket 40, movement of the cross member 18 away from the rocker 22 can be suppressed. Moreover, since the spacer member 30 is covered from above by the bracket 40, upward movement of the spacer member 30 is restricted even if the spacer member 30 attempts to move upward due to a collision load being input to the rocker 22, whereby falling-out of the spacer member 30 can be suppressed, and the collision load can be effectively transmitted from the rocker 22 to the cross member 18.

Moreover, as illustrated in FIG. 3, in the present exemplary embodiment, the spacer member 30 includes the front wall portion 34B and the rear wall portion 34C. Furthermore, the front wall portion 34B is fastened in a state of being overlapped with the surface at the vehicle front side of the cross member 18, and the rear wall portion 34C is fastened in a state of being overlapped with the surface at the vehicle rear side of the cross member 18. Consequently, the spacer member 30 can be fixed at the front and rear of the cross member 18.

Moreover, as illustrated in FIG. 2, in the present exemplary embodiment, the inclined portion 18B of the cross member 18 is formed further upward than the lower end portion of the cross member 18. Consequently, a height of the spacer member 30 in the up-down direction can be designed to be smaller than in a structure in which the inclined portion 18B is formed extending to the lower end portion of the cross member 18.

### Second Exemplary Embodiment

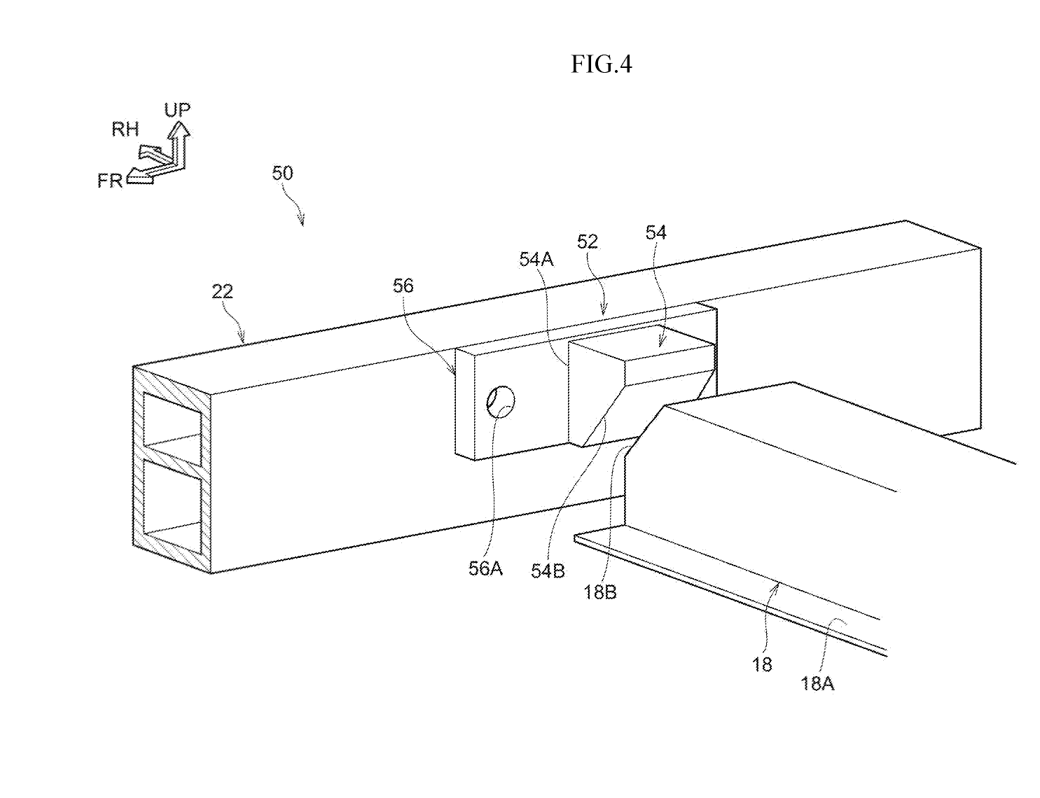

Next, a vehicle frame structure according to a second exemplary embodiment will be explained with reference to FIG. 4. It should be noted that configurations that are the same as those in the first exemplary embodiment are appended with the same reference signs, and explanation thereof is appropriately omitted.

FIG. 4 is a perspective view illustrating relevant portions of a vehicle provided with the vehicle frame structure according to the second exemplary embodiment. As illustrated in FIG. 4, the vehicle 50 to which the vehicle frame structure of the present exemplary embodiment is applied includes a spacer member 52 that is fixed to the rocker 22.

The spacer member 52 is configured to include a main body portion 54 and a flange portion 56. The main body portion 54 is formed in a block shape, and is arranged between the cross member 18 and the rocker 22. A surface at a vehicle width direction outer side of the main body portion 54 is an outer side vertical wall portion 54A that is in surface contact with a surface at a vehicle width direction inner side of the rocker 22 via the flange portion 56.

Further, an inner side inclined portion 54B that is inclined downward on progression from the vehicle width direction inner side toward the vehicle width direction outer side is formed at a surface at a vehicle width direction inner side of the main body portion 54. The inner side inclined portion 54B is arranged at a position that faces the inclined portion 18B of the cross member 18, and is formed at an inclination angle that corresponds to that of the inclined portion 18B.

The flange portion 56 extends in the vehicle front-rear direction along the rocker 22 from the outer side vertical wall portion 54A of the main body portion 54, and is overlapped with the rocker 22. Further, bolt holes 56A are formed at the flange portion 56, and bolts are inserted into the bolt holes 56A, whereby the flange portion 56 is fastened to the rocker 22.

### Operation

Next, operation of the vehicle frame structure according to the present exemplary embodiment will be explained.

In the vehicle 50 to which the vehicle frame structure according to the present exemplary embodiment is applied, since the spacer member 52 is fixed to the rocker 22, the rocker 22 and the spacer member 52 can be modularized in advance. Other operation thereof is the same as in the first exemplary embodiment. It should be noted that, in the present exemplary embodiment, the bracket 40 may be provided similarly as in the first exemplary embodiment. In such a case, falling-out of the spacer member 52 can be suppressed by the bracket 40, even in a case in which a fastening state between the spacer member 52 and the rocker 22 has deteriorated.

### Third Exemplary Embodiment

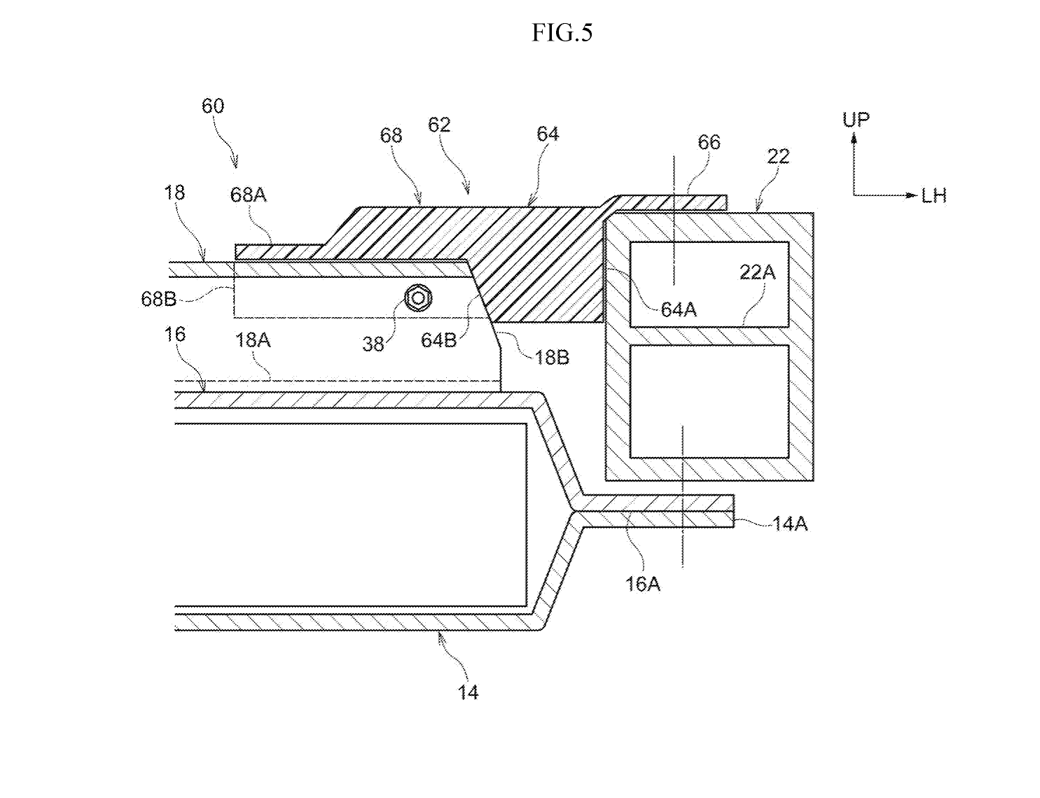

Next, a vehicle frame structure according to a third exemplary embodiment will be explained with reference to FIG. 5. It should be noted that configurations that are the same as those in the first exemplary embodiment are appended with the same reference signs, and explanation thereof is appropriately omitted.

FIG. 5 is an enlarged cross-sectional view illustrating the vehicle frame structure according to the third exemplary embodiment in an enlarged manner. As illustrated in FIG. 5, in a vehicle 60 to which the vehicle frame structure according to the present exemplary embodiment is applied, a spacer member 62 is provided in place of the spacer member 30 of the first exemplary embodiment.

The spacer member 62 is formed from a resin material so as to include a main body portion 64, an outer side attachment portion 66, and an inner side attachment portion 68. The spacer member 62 of the present exemplary embodiment is different from that of the first exemplary embodiment in that it has the functions of the spacer member 30 and the bracket 40 of the first exemplary embodiment.

The main body portion 64 is formed substantially in a block shape, and a lower portion of the main body portion 64 is positioned between the cross member 18 and the rocker 22. Further, a surface at a vehicle width direction outer side of the main body portion 64 is an outer side vertical wall portion 64A that is in surface contact with a surface at a vehicle width direction inner side of the rocker 22, and a surface at a vehicle width direction inner side of the main body portion 64 is an inner side inclined wall portion 64B that is in contact with the inclined portion 18B of the cross member 18.

The outer side attachment portion 66 is integrally molded with the main body portion 64 from a resin, and extends out toward the vehicle width direction outer side from an upper end portion of the main body portion 64. The outer side attachment portion 66 is overlapped with an upper surface of the rocker 22, and the outer side attachment portion 66 and the rocker 22 are fastened by a fastener, which is not illustrated in the drawings.

The inner side attachment portion 68 is integrally molded with the main body portion 64 from a resin, and extends out toward the vehicle width direction inner side from the upper end portion of the main body portion 64. Further, the inner side attachment portion 68 is formed substantially in a U-shape that is open at a lower side as viewed from the vehicle width direction inner side, and is configured to include an upper wall portion 68A, a front wall portion (which is not illustrated in the drawings) that extends out downward from a front end portion of the upper wall portion 68A, and a rear wall portion 68B that extends out downward from a rear end portion of the upper wall portion 68A. The upper wall portion 68A extends in the vehicle width direction and the vehicle front-rear direction, and is overlapped with an upper surface of an end portion of the cross member 18.

Further, an end portion at a vehicle width direction inner side of the upper wall portion 68A is formed with a thin plate thickness, and is fastened to the upper surface of the cross member 18 by a fastener, which is not illustrated in the drawings. The front wall portion and the rear wall portion 68B are shaped to be fastened to the cross member 18 in a state in which they are respectively overlapped with a surface at a vehicle front side of the end portion of the cross member 18 and a surface at a vehicle rear side of the end portion of the cross member 18. Furthermore, the front wall portion and the rear wall portion 68B are fastened to the cross member 18 at the positions of the weld nuts 38.

### Operation

Next, operation of the vehicle frame structure according to the present exemplary embodiment will be explained.

In the vehicle 60 to which the vehicle frame structure according to the present exemplary embodiment is applied, since the spacer member 62 also performs the function of the bracket 40 of the first exemplary embodiment, the number of components can be reduced compared to the first exemplary embodiment. Further, since the spacer member 62 is fastened to the cross member 18 at plural locations at the inner side attachment portion 68, a fastening state between the spacer member 62 and the cross member 18 can be favorably maintained. Other operation thereof is the same as in the first exemplary embodiment.

Although the first exemplary embodiment to third exemplary embodiment according to the present disclosure have been explained above, it is needless to say that various embodiments can be implemented in a range that does not depart from the spirit of the present disclosure. For example, although the inclined portion 18B of the cross member 18 is formed further upward than the lower end portion of the cross member 18 in the above-described exemplary embodiments as illustrated in FIG. 2, there is no limitation thereto, and a structure in which the inclined portion is formed extending to the lower end portion of the cross member may be employed.

Further, a structure in which the first exemplary embodiment and the second exemplary embodiment are combined may be employed. In such a case, since the end portion at the vehicle width direction outer side of the spacer member is fastened to the rocker, and the end portion at the vehicle width direction inner side of the spacer member is fastened to the cross member, there is no need to separately provide a bracket or the like.

Furthermore, the shapes of the cross member, the rocker, the spacer member, and the bracket that have been explained in the above-described exemplary embodiments are merely examples thereof, and other shapes may be employed.

Moreover, in the above-described exemplary embodiments, although a configuration is provided in which no floor panel is provided due the cross member 18 being fixed to the upper surface of the case cover 16 of the battery case 12 as illustrated in FIG. 1, there is no limitation thereto. For example, a structure may be employed in which a floor panel is provided separately from the battery case, and the cross member 18 is fixed to the floor panel.

With regard to the above-described exemplary embodiments, the following additional notes are further disclosed.

### Additional Note 1

A vehicle frame structure including:

a pair of rockers that are provided at both vehicle width direction sides, and that extend in a vehicle front-rear direction;

a cross member that is provided between the pair of rockers apart from the rockers, that extends in a vehicle width direction, and that includes inclined portions that are inclined downward on progression from a vehicle width direction inner side toward a vehicle width direction outer side at both vehicle width direction sides; and

a spacer member configured to include an outer side vertical wall portion that is in surface contact with a surface at a vehicle width direction inner side of a rocker, and an inner side inclined wall portion that is in contact with an inclined portion of the cross member.

### Additional Note 2

The vehicle frame structure according to Additional Note 1, further including a bracket that is provided above the spacer member, and that is fastened to the rocker and the cross member.

### Additional Note 3

The vehicle frame structure according to Additional Note 1 or Additional Note 2, wherein the spacer member includes a front wall portion that is fastened to the cross member in a state of being overlapped with a surface at a vehicle front side of the cross member, and a rear wall portion that is fastened to the cross member in a state of being overlapped with a surface at a vehicle rear side of the cross member.

### Additional Note 4

The vehicle frame structure according to any one of Additional Note 1 to Additional Note 3, wherein the inclined portions are formed further upward than a lower end portion of the cross member.

### Additional Note 5

The vehicle frame structure according to any one of Additional Note 1 to Additional Note 4, wherein:

the spacer member includes a flange portion that extends in the vehicle front-rear direction along the rocker from the outer side vertical wall portion, and

the flange portion and the rocker are fastened to each other.

WHAT IS CLAIMED IS:

1. A vehicle frame structure comprising:
a pair of rockers that are provided at both vehicle width direction sides, and that extend in a vehicle front-rear direction;
a cross member that is provided between the pair of rockers apart from the rockers, that extends in a vehicle width direction, and that includes inclined portions that are inclined downward on progression from a vehicle width direction inner side toward a vehicle width direction outer side at both vehicle width direction sides; and
a spacer member configured to include an outer side vertical wall portion that is in surface contact with a surface at a vehicle width direction inner side of a rocker, and an inner side inclined wall portion that is in contact with an inclined portion of the cross member.

2. The vehicle frame structure according to claim 1, further comprising a bracket that is provided above the spacer member, and that is fastened to the rocker and the cross member.

3. The vehicle frame structure according to claim 1, wherein the spacer member includes a front wall portion that is fastened to the cross member in a state of being overlapped with a surface at a vehicle front side of the cross member, and a rear wall portion that is fastened to the cross member in a state of being overlapped with a surface at a vehicle rear side of the cross member.

4. The vehicle frame structure according to claim 1, wherein the inclined portions are formed further upward than a lower end portion of the cross member.

5. The vehicle frame structure according to claim 1, wherein:
the spacer member includes a flange portion that extends in the vehicle front-rear direction along the rocker from the outer side vertical wall portion, and
the flange portion and the rocker are fastened to each other.
